(19) United States
(12) Patent Application Publication
(10) Pub. No.: US 2016/0210776 A1
(43) Pub. Date: Jul. 21, 2016

(54) Image Processing Apparatus, System, Method and Computer Program Product for 3D Reconstruction

(71) Applicant: UNIVERSITÄT HEIDELBERG, Heidelberg (DE)

(72) Inventors: Sven Wanner, Heidelberg (DE); Bernd Jaehne, Hanau (DE); Bastian Goldluecke, Mannheim (DE)

(73) Assignee: Universitat Heidelberg, Heidelberg (DE)

(21) Appl. No.: 14/915,591

(22) PCT Filed: Sep. 2, 2013
(86) PCT No.: PCT/EP2013/002624

§ 371 Date: Feb. 29, 2016

(51) Int. Cl. G06T 15/20; G06T 15/50; H04N 5/247; G06T 7/00

(52) U.S. Cl. CPC G06T 15/205; G06T 7/0065; G06T 15/50; H04N 5/247; G06T 2207/10052; G06T 2207/10028; G06T 2207/20228

(57) ABSTRACT

An image processing apparatus for 3D reconstruction is provided. The image processing apparatus may comprise: an epipolar plane image generation unit configured to generate a first set of epipolar plane images from a first set of images of a scene, the first set of images being captured from a plurality of locations; an orientation determination unit configured to determine, for pixels in the first set of epipolar plane images, two or more orientations of lines passing through any one of the pixels; and a 3D reconstruction unit configured to determine disparity values or depth values for pixels in an image of the scene based on the orientations determined by the orientation determination unit.

The application relates to an image processing apparatus for 3D reconstruction.

For 3D reconstruction, multi-view stereo methods are known. Multi-view stereo methods are typically designed to find the same imaged scene point P in at least two images captured from different viewpoints. Since the difference in the positions of P in the corresponding image plane coordinate systems directly depends on the distance of P from the image plane, identifying the same point P in different images captured from different viewpoints enables reconstruction of depth information of the scene. In other words, multi-view stereo methods rely on a detection of corresponding regions present in images captured from different viewpoints. Existing methods for such detection are usually based on the assumption that a scene point looks the same in all views where it is observed. For the assumption to be valid, the scene surfaces need to be diffuse reflectors, i.e. Lambertian. Although this assumption does not apply in most natural scenes, one may usually obtain robust results at least for surfaces which exhibit only small amounts of specular reflections.

In the presence of partially reflecting surfaces, however, it is very challenging for a correspondence matching method based on comparison of image colors to reconstruct accurate depth information. The overlay of information from surface and reflection may result in ambiguous reconstruction information, which might lead to a failure of matching based methods.

An approach for 3D reconstruction different from multi-view stereo methods is disclosed in Wanner and Goldluecke, “Globally Consistent Depth Labeling of 4D Light Fields”, In: Proc. International Conference on computer Vision and Pattern Recognition, 2012, p. 41-48. This approach employs “4D light fields” instead of 2D images used in multi-view stereo methods. A “4D light field” contains information about not only the accumulated intensity at each image point, but separate intensity values for each ray direction. A “4D light field” may be obtained by, for example, capturing images of a scene with cameras arranged in a grid. The approach introduced by Wanner and Goldluecke constructs “epipolar plane images” which may be understood as vertical and horizontal 2D cuts through the “4D light field”, and then analyzes the epipolar plane images for depth estimation. In this approach, no correspondence matching is required. However, the image formation model implicitly underlying this approach is still the Lambertian one.

Accordingly, a challenge remains in 3D reconstruction of a scene including non-Lambertian surfaces, or so called non-cooperative surfaces, such as metallic surfaces or more general materials showing reflective properties or semi-transparencies.

According to one aspect, an image processing apparatus for 3D reconstruction is provided. The image processing apparatus may comprise the following:
an epipolar plane image generation unit configured to generate a first set of epipolar plane images from a first set of images of a scene, the first set of images being captured from a plurality of locations;
an orientation determination unit configured to determine, for pixels in the first set of epipolar plane images, two or more orientations of lines passing through any one of the pixels; and
a 3D reconstruction unit configured to determine disparity values or depth values for pixels in an image of the scene based on the orientations determined by the orientation determination unit.

In various aspects stated herein, an “epipolar plane image” may be understood as an image including a stack of corresponding rows or columns of pixels taken from a set of images captured from a plurality of locations. The plurality of locations may be arranged in a linear array with equal intervals in relation to the scene. Further, in various aspects, the “lines passing through any one of the pixels” may be understood as lines passing through a same, single pixel. In addition, the “lines” may include straight lines and/or curved lines.

The orientation determination unit may comprise a double orientation model unit that is configured to determine two orientations of lines passing through any one of the pixels. One of the two orientations may correspond to a pattern representing a surface in the scene. The other one of the two orientations may correspond to a pattern representing a reflection on the surface or a pattern representing an object behind the surface that is transparent.

The orientation determination unit may comprise a triple orientation model unit that is configured to determine three orientations of lines passing through any one of the pixels. The three orientations may respectively correspond to three patterns of the following patterns, i.e. each of the three orientations may correspond to one of three patterns of the following patterns:
a pattern representing a transparent surface in the scene;
a pattern representing a reflection on a transparent surface in the scene;
a pattern representing an object behind a transparent surface in the scene;
a pattern representing a reflection on a surface of an object behind a transparent surface in the scene;
a pattern representing a transparent surface in the scene behind another transparent surface in the scene; and
a pattern representing an object behind two transparent surfaces in the scene

In one example, the three orientations may respectively correspond to: a pattern representing a transparent surface in the scene; a pattern representing a reflection on the transparent surface; and a pattern representing an object behind the transparent surface.

In another example, the three orientations may respectively correspond to: a pattern representing a transparent surface in the scene; a pattern representing an object behind the transparent surface; and a pattern representing a reflection on a surface of the object behind the transparent surface.

In yet another example, the three orientations may respectively correspond to: a pattern representing a first transparent surface in the scene; a pattern representing a second transparent surface behind the first transparent surface; and a pattern representing an object behind the second transparent surface.

The determination of the two or more orientations may include an Eigensystem analysis of a second or higher order structure tensor on the epipolar plane image.

The epipolar plane image generation unit may be further configured to generate a second set of epipolar plane images from a second set of images of the scene, the second set of images being captured from a plurality of locations that are arranged in a direction different from a direction of arrangement for the plurality of locations from which the first set of images are captured. The orientation determination unit may be further configured to determine, for pixels in the second set of epipolar plane images, two or more orientations of lines passing through any one of the pixels.

The orientation determination unit may further comprise a single orientation model unit that is configured to determine, for pixels in the first set of epipolar plane images and for pixels in the second set of epipolar plane images, a single orientation of a line passing through any one of the pixels. The image processing apparatus may further comprise a selection unit that is configured to select, according to a predetermined rule, the single orientation or the two or more orientations to be used by the 3D reconstruction unit for determining the disparity values or depth values.

The predetermined rule may be defined to select:
the single orientation when the two or more orientations determined for corresponding pixels in the first set and the second set of epipolar plane images represent disparity or depth values with an error greater than a predetermined threshold; and
the two or more orientations when the two or more orientations determined for corresponding pixels in the first set and the second set of epipolar plane images represent disparity or depth values with an error less than or equal to the predetermined threshold.

Here, the term “error” may indicate a difference between a disparity or depth value obtained from one of the two or more orientations determined for a pixel in one of the first set of epipolar plane images and a disparity or depth value obtained from a corresponding orientation determined for a corresponding pixel in one of the second set of epipolar plane images.

Further, the 3D reconstruction unit may be configured to determine the disparity values or the depth values for pixels in the image of the scene by performing statistical operations on the two or more orientations determined for corresponding pixels in epipolar plane images in the first set and the second set of epipolar plane images.

An exemplary statistical operation is to take a mean value.

For determining the disparity values or the depth values for pixels in the image of the scene, the 3D reconstruction unit may be further configured to select, according to predetermined criteria, whether to use:
the two or more orientations determined from the first set of epipolar plane images; or
the two or more orientations determined from the second set of epipolar plane images.

According to another aspect, a system for 3D reconstruction is provided. The system may comprise: any one of the variations of the image processing apparatus aspects as described above; and a plurality of imaging devices that are located at the plurality of locations and that are configured to capture images of the scene.

The plurality of imaging devices may be arranged in two or more linear arrays intersecting with each other

According to yet another aspect, a system for 3D reconstruction is provided. The system may comprise: any one of the variations of the image processing apparatus aspects as described above; and at least one imaging device that is configured to capture images of the scene from the plurality of locations. For example, said at least one imaging device may be movable and controlled to move from one location to another. In a more specific example, said at least one imaging device may be mounted on a stepper-motor and moved from one location to another.

According to yet another aspect, an image processing method for 3D reconstruction is provided. The method may comprise the following:
generating a first set of epipolar plane images from a first set of images of a scene, the first set of images being captured from a plurality of locations;
determining, for pixels in the first set of epipolar plane images, two or more orientations of lines passing through any one of the pixels; and
determining disparity values or depth values for pixels in an image of the scene based on the determined orientations.

The determination of the two or more orientations may include determining two orientations of lines passing through any one of the pixels. One of the two orientations may correspond to a pattern representing a surface in the scene. The other one of the two orientations may correspond to a pattern representing a reflection on the surface or a pattern representing an object behind the surface that is transparent.

The determination of the two or more orientations may include determining three orientations of lines passing through any one of the pixels. The three orientations may respectively correspond to: a pattern representing a transparent surface in the scene; a pattern representing a reflection on the transparent surface; and a pattern representing an object behind the transparent surface.

The determination of the two or more orientations may include an Eigensystem analysis of a second or higher order structure tensor on the epipolar plane image.

The method may further comprise:
generating a second set of epipolar plane images from a second set of images of the scene, the second set of images being captured from a plurality of locations that are arranged in a direction different from a direction of arrangement for the plurality of locations from which the first set of images are captured; and
determining, for pixels in the second set of epipolar plane images, two or more orientations of lines passing through any one of the pixels.

The method may further comprise:
determining, for pixels in the first set of epipolar plane images and for pixels in the second set of epipolar plane images, a single orientation of a line passing through any one of the pixels; and
selecting, according to a predetermined rule, the single orientation or the two or more orientations to be used by the 3D reconstruction unit for determining the disparity values or depth values.

According to yet another aspect, a computer program product is provided. The computer program product may comprise computer-readable instructions that, when loaded and run on a computer, cause the computer to perform any one of the variations of method aspects as described above.

The subject matter described in the application can be implemented as a method or as a system, possibly in the form of one or more computer program products. The subject matter described in the application can be implemented in a data signal or on a machine readable medium, where the medium is embodied in one or more information carriers, such as a CD-ROM, a DVD-ROM, a semiconductor memory, or a hard disk. Such computer program products may cause a data processing apparatus to perform one or more operations described in the application.

In addition, subject matter described in the application can also be implemented as a system including a processor, and a memory coupled to the processor. The memory may encode one or more programs to cause the processor to perform one or more of the methods described in the application. Further subject matter described in the application can be implemented using various machines.

Details of one or more implementations are set forth in the exemplary drawings and description below. Other features will be apparent from the description, the drawings, and from the claims.

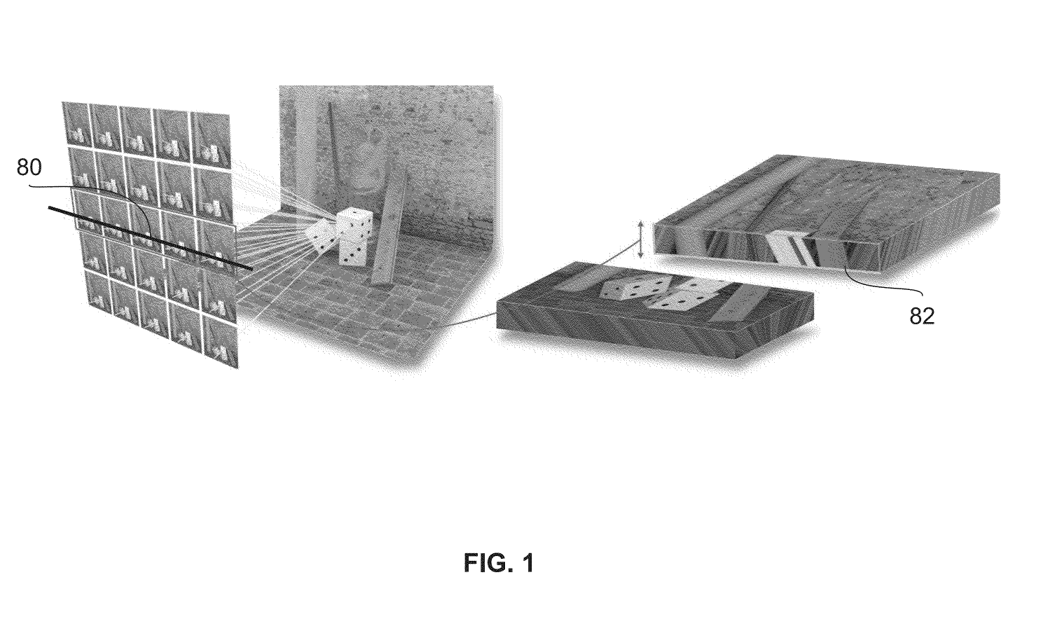

FIG. 1 shows an example of a 4D light field structure.

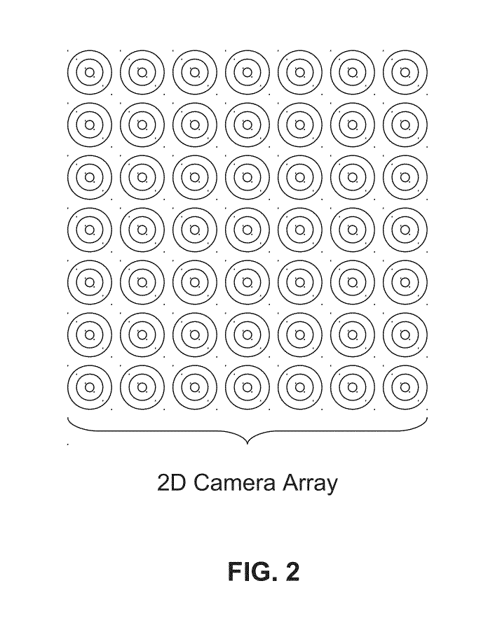

FIG. 2 shows an example of a 2D camera array for capturing a collection of images.

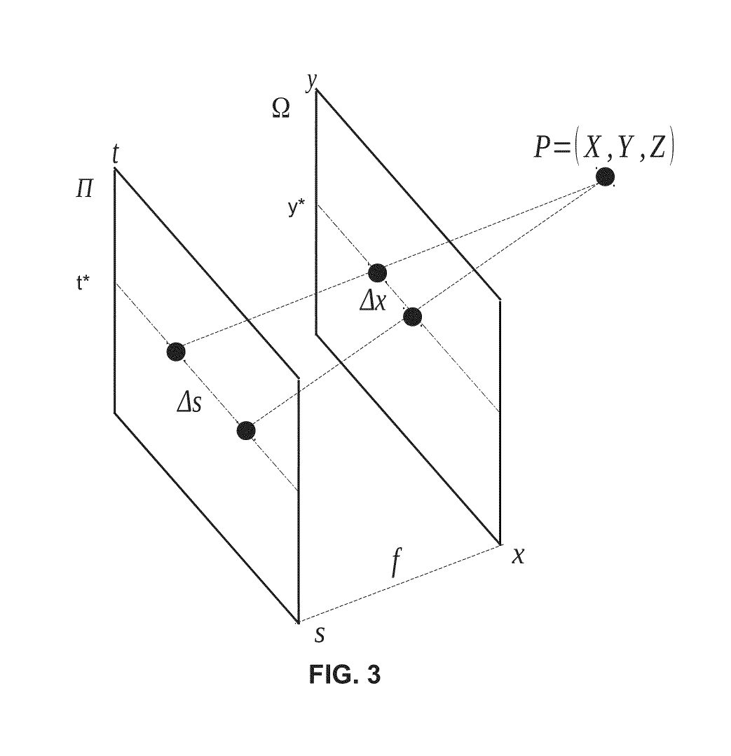

FIG. 3 shows an example of light field geometry.

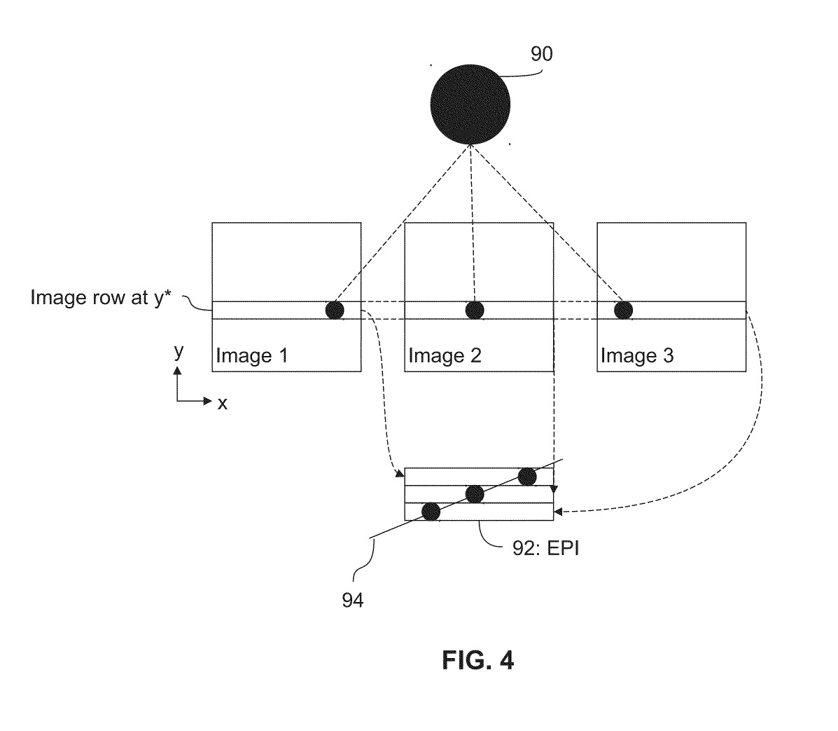

FIG. 4 shows a simplified example of how to generate an EPI.

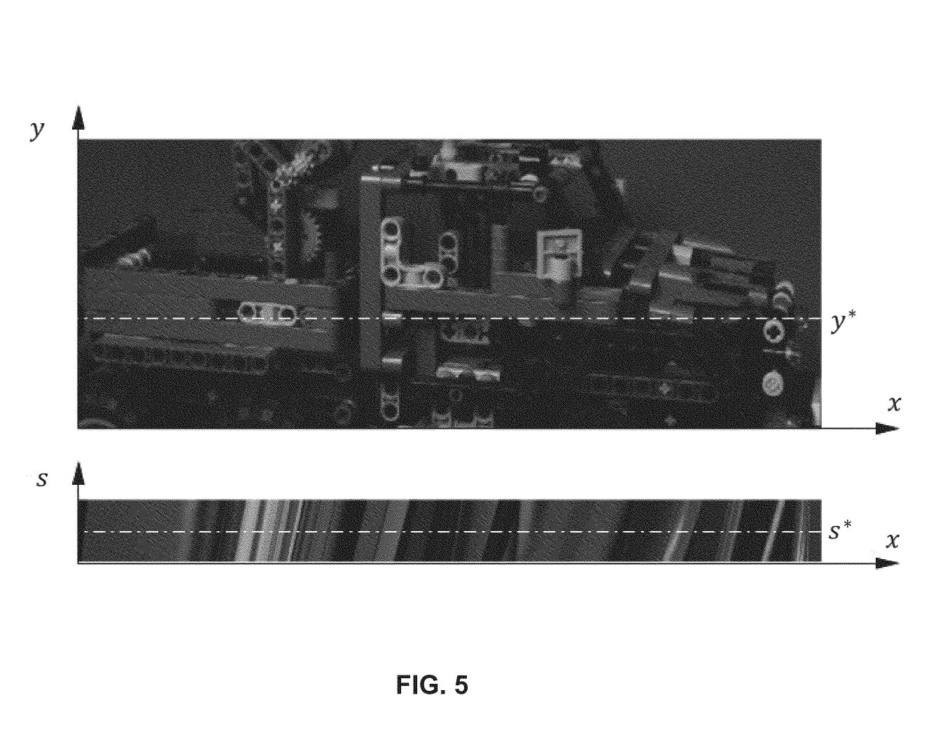

FIG. 5 shows an example of a pinhole view and an example of an EPI.

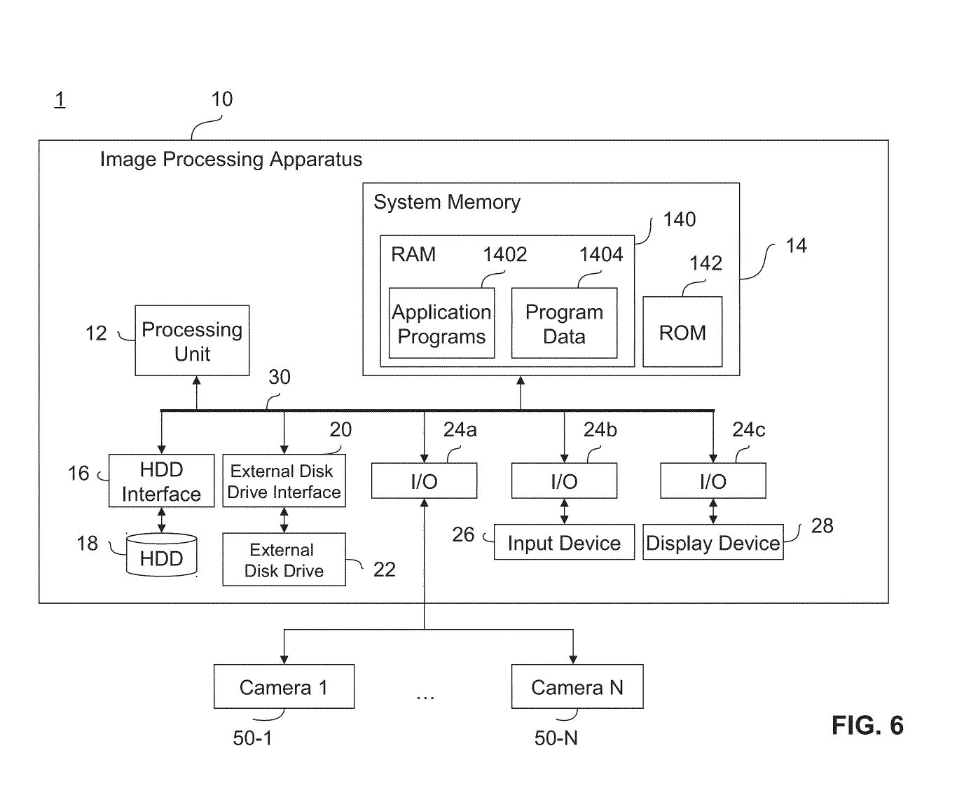

FIG. 6 shows an exemplary hardware configuration of a system for 3D reconstruction according to an embodiment.

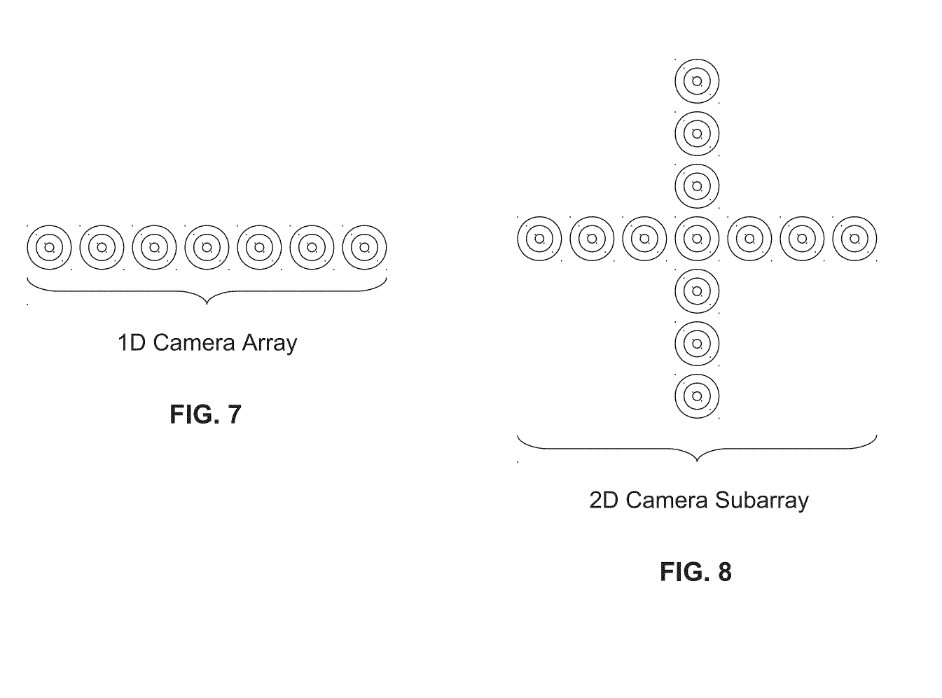

FIG. 7 shows an example of a 1D camera array.

FIG. 8 shows an example of a 2D camera subarray.

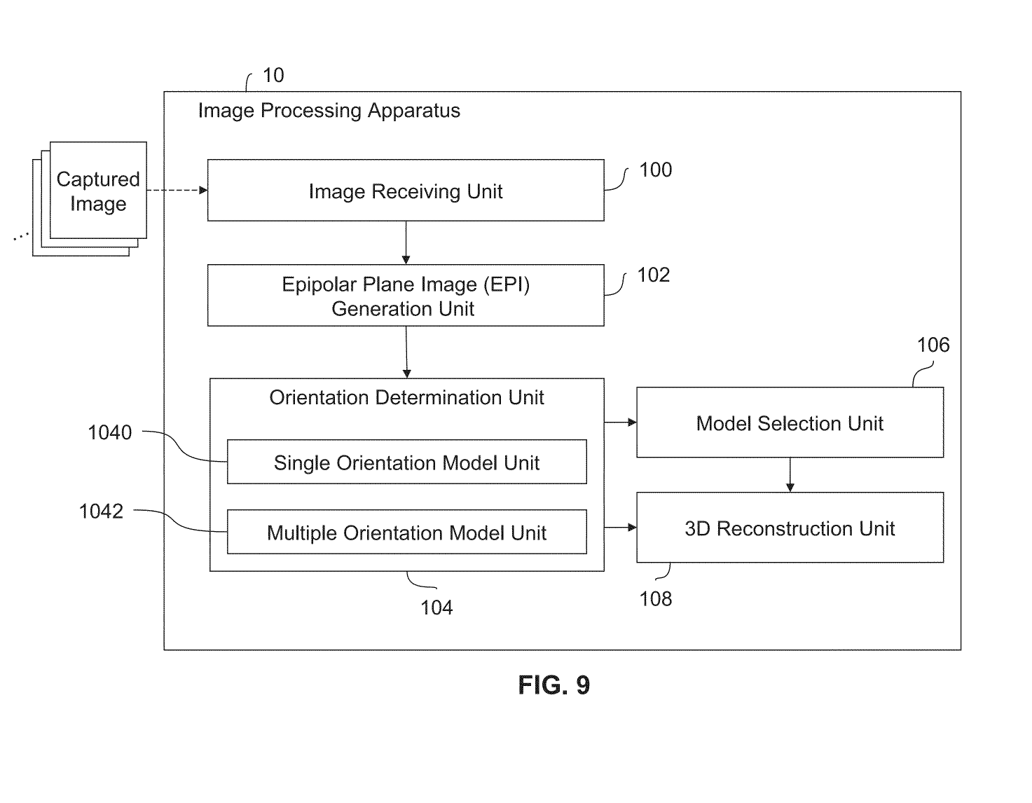

FIG. 9 shows an exemplary functional block diagram of an image processing apparatus.

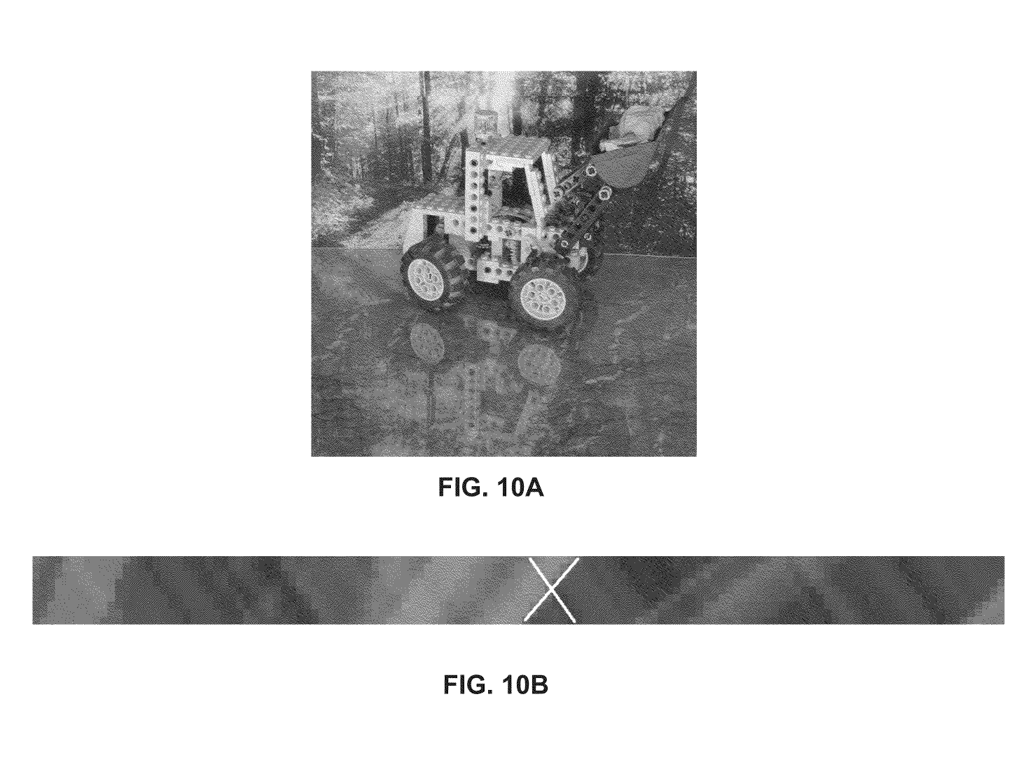

FIG. 10A shows an example of a captured image of a scene including a reflective surface.

FIG. 10B shows an example of an EPI generated using captured images of a scene with a reflective surface as shown in FIG. 10A.

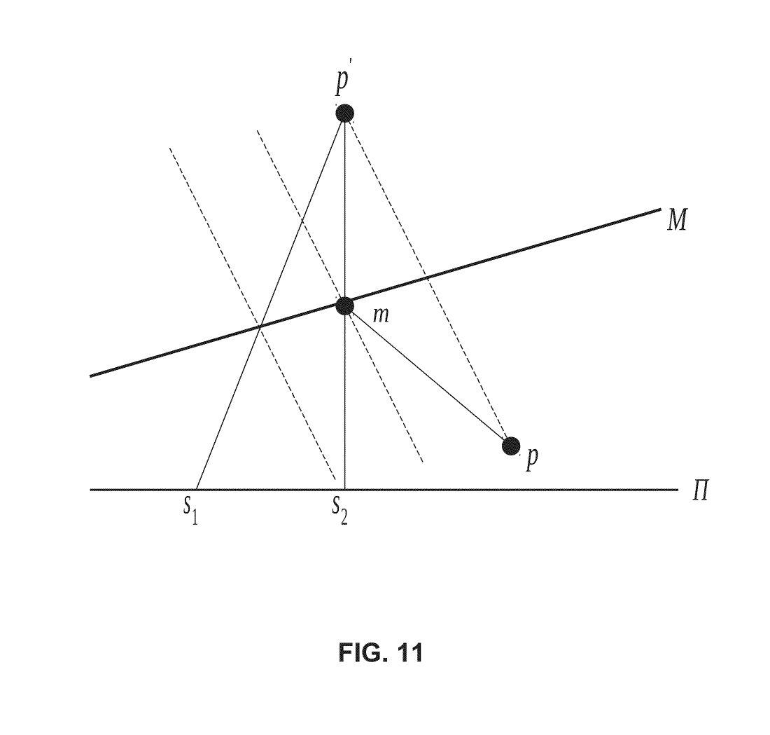

FIG. 11 shows an example of a mirror plane geometry.

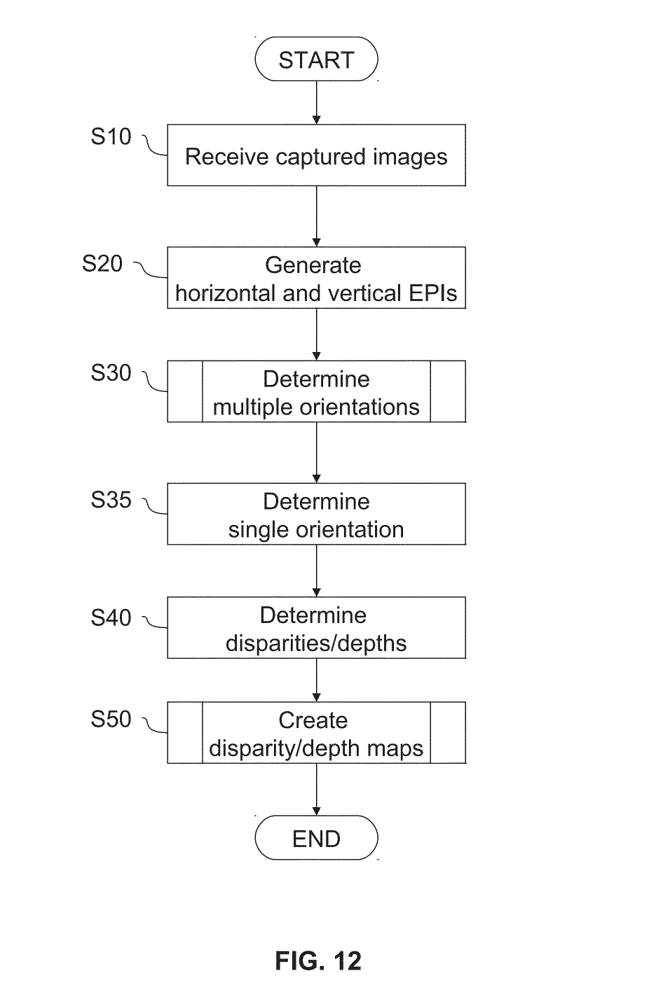

FIG. 12 shows a flowchart of exemplary processing performed by the image processing apparatus.

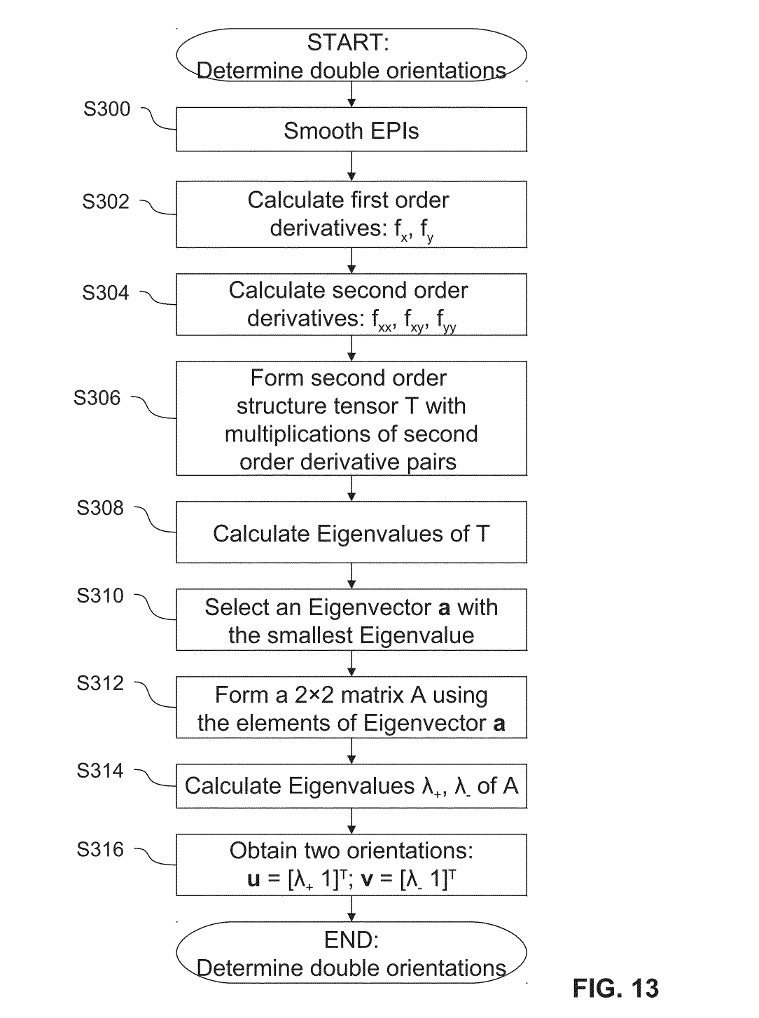

FIG. 13 shows a flowchart of exemplary processing for determining two orientations for any one of the pixels of the EPIs.

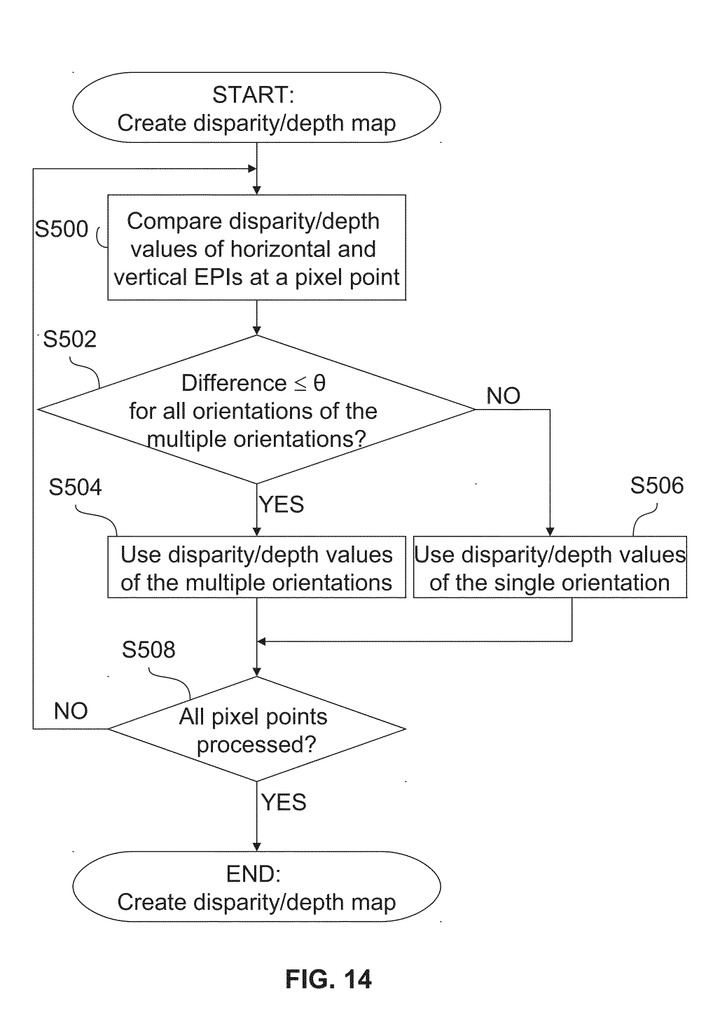

FIG. 14 shows a flowchart of exemplary processing for creating a disparity map for an image to be reconstructed.

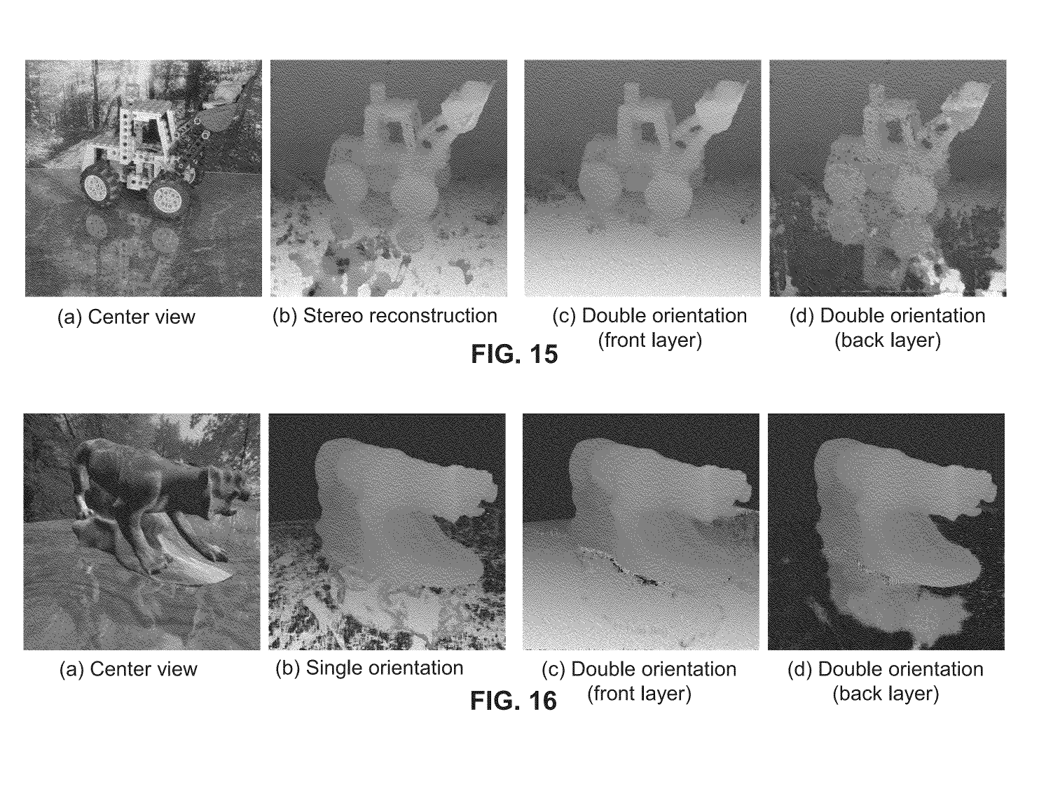

FIG. 15 shows an example of experimental results of 3D reconstruction.

FIG. 16 shows another example of experimental results of 3D reconstruction.

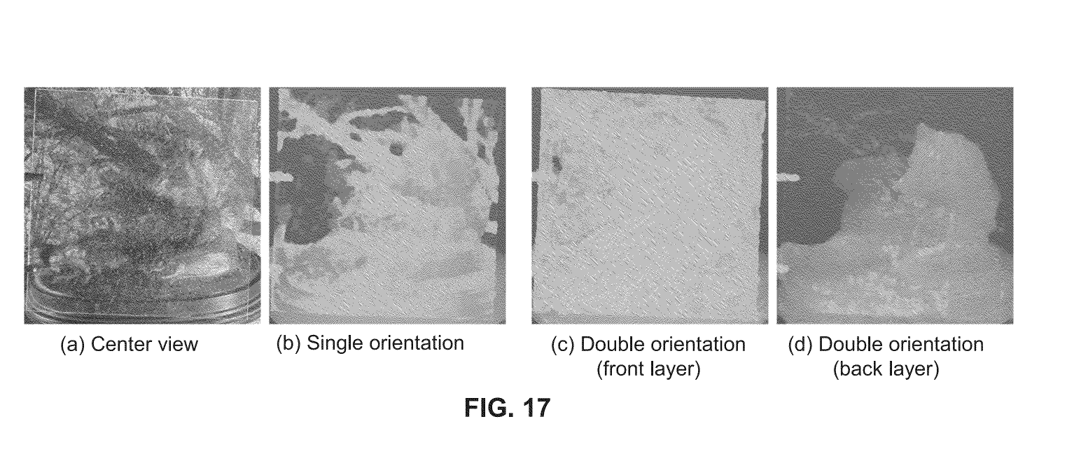

FIG. 17 shows yet another example of experimental results of 3D reconstruction.

In the following text, a detailed description of examples will be given with reference to the drawings. It should be understood that various modifications to the examples may be made. In particular, elements of one example may be combined and used in other examples to form new examples.

### “Light Fields” and “Epipolar Plane Images”

Exemplary embodiments as described herein deal with “light fields” and “epipolar plane images”. The concepts of “light fields” and “epipolar plane images” will be explained below.

A light field comprises a plurality of images captured by imaging device(s) (e.g. camera(s)) from different locations that are arranged in a linear array with equal intervals in relation to a scene to be captured. When a light field includes images captured from locations arranged linearly, the light field is called a “3D light field”. When a light field includes images captured from locations arranged in two orthogonal directions (i.e. the camera(s) capture images from a 2D grid), the light field is called “4D light field”.

FIG. 1 shows an example of a 4D light field structure. A 4D light field is essentially a collection of images of a scene, where the focal points of the cameras lie in a 2D plane as shown in the left half of FIG. 1. An example of a 2D camera array for capturing such a collection of images is shown in FIG. 2.

Referring again to FIG. 1, an additional structure becomes visible when one stacks all images along a line of viewpoints on top of each other and considers a cut through this stack. The 2D image in the plane of the cut is called an “epipolar plane image” (EPI). For example, if all images along a line 80 in FIG. 1 are stacked and the stack is cut through at a line corresponding to the line 80, a cross-sectional surface 82 in FIG. 1 is an EPI.

Referring now to FIG. 3, a 4D light field may be understood as a collection of pinhole views with a same image plane Ω and focal points lying in a second parallel plane Π. The 2D plane Π contains the focal points of the views and is parametrized by coordinates (s, t). The image plane Ω is parametrized by coordinates (x, y). Each camera location (s, t) in the view point plane Π yields a different pinhole view of the scene. A 4D light field L is a map which assigns an intensity value (grayscale or color) to each ray:

L:Ω×Π→ [symbol] ,(x,y,s,t) [symbol] L(x,y,s,t) (1),

where the symbol [symbol] indicates the space of real numbers. The map of Equation (1) may be viewed as an assignment of an intensity value to the ray R_{x, y, s, t} passing through (x, y)εΩ and (s, t)εΠ. For 3D reconstruction, the structure of the light field is considered, in particular on 2D slices through the field. In other words, of particular interest are the images which emerge when the space of rays is restricted to a 2D plane. For example, if the two coordinates (y*, t*) are fixed, the restriction L_{y*, t*} may be the following map:

L_{y*,t*}:(x,s) [symbol] L(x,y*,s,t*) (2).

Other restrictions may be defined in a similar way. Note that L_{s*, t*} is the image of the pinhole view with center of projection (s*, t*). The images L_{y*, t*} and L_{x*, s*} are called “epipolar plane images” (EPIs). These images may be interpreted as horizontal or vertical cuts through a horizontal or vertical stack of the views in the light field, as can be seen, for example, from FIG. 1. Hereinafter, the EPI L_{y*, t*} obtained by fixing coordinates (y*, t*) may be referred to as a “horizontal EPI”. Similarly, the EPI L_{x*, s*} obtained by fixing coordinates (x*, s*) may be referred to as a “vertical EPI”. These EPIs may have a rich structure which resembles patterns of overlaid straight lines. The slope of the lines yields information about the scene structure. For instance, as shown in FIG. 3, a point P=(X, Y, Z) within the epipolar plane corresponding to the slice projects to a point in Ω depending on the chosen camera center in Π. If s is varied, the coordinate x may change as follows:

$$Δ x = - \frac{f}{Z} Δ s \qquad ( 3 )$$

where f is the focal length, i.e. the distance between the parallel planes and Z is the depth of P, i.e. distance of P to the plane Π. The quantity f/Z is referred to as the disparity of P. Accordingly, a point P in 3D space is projected onto a line in a slice of the light field, i.e. an EPI, where the slope of the line is related to the depth of point P. The exemplary embodiments described herein perform 3D reconstruction using this relationship between the slope of the line in an EPI and the depth of the point projected on the line.

FIG. 4 shows a simplified example of how to generate an EPI, i.e. an epipolar plane image. FIG. 4 shows an example of a case in which an object 90 is captured from three viewpoints (not shown) arranged in a linear array with equal intervals. The example of FIG. 4 thus involves a 3D light field. Images 1, 2 and 3 in FIG. 4 indicate example images captured from the three viewpoints. An image row at position y* in the y direction in each of images 1 to 3 may be copied from images 1 to 3 and stacked on top of each other, which may result in an EPI 92. As can be seen from FIG. 4, the same object 90 may appear at different positions in the x direction in images 1 to 3. The slope of a line 94 that passes through points at which the object 90 appears may encode a distance between the object 90 and the camera plane (not shown).

FIG. 5 shows an example of a pinhole view and an example of an EPI. The upper image in FIG. 5 shows an example of a pinhole view captured from a view point (s*, t*). The lower image in FIG. 5 shows an example of an EPI L_{y*, t*} generated using the exemplary pinhole view (see Equation (2)).

### Hardware Configurations

Hardware configurations that may be employed in exemplary embodiments will be explained below.

FIG. 6 shows an exemplary hardware configuration of a system for 3D reconstruction according to an embodiment. In FIG. 6, a system 1 includes an image processing apparatus 10 and cameras 50-1, . . . , 50-N. The image processing apparatus 10 may be implemented by a general purpose computer, for example, a personal computer.

The image processing apparatus 10 shown in FIG. 6 includes a processing unit 12, a system memory 14, hard disk drive (HDD) interface 16, external disk drive interface 20, and input/output (I/O) interfaces 24. These components of the image processing apparatus 10 are coupled to each other via a system bus 30. The processing unit 12 may perform arithmetic, logic and/or control operations by accessing the system memory 14. The system memory 14 may store information and/or instructions for use in combination with the processing unit 12. The system memory 14 may include volatile and non-volatile memory, such as a random access memory (RAM) 140 and a read only memory (ROM) 142. A basic input/output system (BIOS) containing the basic routines that helps to transfer information between elements within the general purpose computer, such as during start-up, may be stored in the ROM 142. The system bus 30 may be any of several types of bus structures including a memory bus or memory controller, a peripheral bus, and a local bus using any of a variety of bus architectures.

The image processing apparatus shown in FIG. 6 may include a hard disk drive (HDD) 18 for reading from and writing to a hard disk (not shown), and an external disk drive 22 for reading from or writing to a removable disk (not shown). The removable disk may be a magnetic disk for a magnetic disk drive or an optical disk such as a CD ROM for an optical disk drive. The HDD 18 and the external disk drive 22 are connected to the system bus 30 by a HDD interface 16 and an external disk drive interface 20, respectively. The drives and their associated computer-readable media provide non-volatile storage of computer-readable instructions, data structures, program modules and other data for the general purpose computer. The data structures may include relevant data for the implementation of the method for 3D reconstruction, as described herein. The relevant data may be organized in a database, for example a relational or object database.

Although the exemplary environment described herein employs a hard disk (not shown) and an external disk (not shown), it should be appreciated by those skilled in the art that other types of computer readable media which can store data that is accessible by a computer, such as magnetic cassettes, flash memory cards, digital video disks, random access memories, read only memories, and the like, may also be used in the exemplary operating environment.

A number of program modules may be stored on the hard disk, external disk, ROM 142 or RAM 140, including an operating system (not shown), one or more application programs 1402, other program modules (not shown), and program data 1404. The application programs may include at least a part of the functionality as will be described below, referring to FIGS. 9 to 14.

The image processing apparatus 10 shown in FIG. 6 may also include an input device 26 such as mouse and/or keyboard, and display device 28, such as liquid crystal display. The input device 26 and the display device 28 are connected to the system bus 30 via I/O interfaces 20b, 20c.

It should be noted that the above-described image processing apparatus 10 employing a general purpose computer is only one example of an implementation of the exemplary embodiments described herein. For example, the image processing apparatus 10 may include additional components not shown in FIG. 6, such as network interfaces for communicating with other devices and/or computers.

In addition or as an alternative to an implementation using a general purpose computer as shown in FIG. 6, a part or all of the functionality of the exemplary embodiments described herein may be implemented as one or more hardware circuits. Examples of such hardware circuits may include but are not limited to: Large Scale Integration (LSI), Application Specific Integrated Circuit (ASIC) and Field Programmable Gate Array (FPGA).

Cameras 50-1, . . . , 50-N shown in FIG. 6 are imaging devices that can capture images of a scene. Cameras 50-1, . . . , 50-N may be connected to the system bus 30 of the general purpose computer implementing the image processing apparatus 10 via the I/O interface 20a. An image captured by a camera 50 may include a 2D array of pixels. Each of the pixels may include at least one value. For example, a pixel in a grey scale image may include one value indicating an intensity of the pixel. A pixel in a color image may include multiple values, for example three values, that indicate coordinates in a color space such as RGB color space. In the following, the exemplary embodiments will be described in terms of grey scale images, i.e. each pixel in a captured image includes one intensity value. However, it should be appreciated by those skilled in the art that the exemplary embodiments may be applied also to color images. For example, color images may be converted into grey scale images and then the methods of the exemplary embodiments may directly be applied to the grey scale images. Alternatively, for example, the methods of the exemplary embodiments may be applied to each of the color channels of a pixel in a color image.

Cameras 50-1, . . . , 50-N in FIG. 6 may be arranged to enable obtaining a 3D or 4D light field. For example, cameras 50-1, . . . , 50-N may be arranged in an m×n 2D array as shown in FIG. 2 (in which case m=n=7).

In another example, cameras 50-1, . . . , 50-N may be arranged in a 1D array as shown in FIG. 7. By capturing a scene once with the 1D camera array shown in FIG. 7, a 3D light field may be obtained. A 4D light field may also be obtained by the 1D camera array shown in FIG. 7, if, for example, the 1D camera array is moved along a direction perpendicular to the direction of the 1D camera array and captures the scene a required number of times at different locations with equal intervals.

FIG. 8 shows yet another example of camera arrangement. In FIG. 8, cameras are arranged in a cross. This arrangement enables obtaining a 4D light field. A cross arrangement of cameras may include two linear camera arrays intersecting each other. Further, a cross arrangement of cameras may be considered as a subarray of a full 2D camera array. For instance, the cross arrangement of cameras shown in FIG. 8 may be obtained by removing cameras from the full 2D array as shown in FIG. 2, except for the cameras in central arrays.

A fully populated array of cameras may not be necessary to achieve high quality results in the exemplary embodiments, if a single viewpoint of range information (depth information) is all that is desired. Image analysis based on filtering, as in the exemplary embodiments described herein, may result in artefact effects at the image borders. In particular, when analyzing EPIs with relatively few pixels along the viewpoint dimensions, the images captured by cameras in the central arrays of a full 2D array may contribute more to the maximal achievable quality in comparison to images captured by cameras at other locations in the full 2D array. Clearly, the quality of estimation may be dependent on the number of observations along the viewpoint dimension. Accordingly, the cross arrangement of cameras as shown in FIG. 8 may achieve results of a level of quality as high as those may be achieved by a full 2D camera array as shown in FIG. 2, with smaller number of cameras. This leads to an array camera setup with no waste in quality of range estimation, and with (n−1)̂2 fewer cameras in comparison to an n×n camera array, or more generally, n+(m−1) instead of m×n cameras. As a concrete example, consider a 7×7=49-camera array, as shown in FIG. 2. Here, the resulting EPIs will be 7 pixels in height. The same image quality could be achieved with 7+6=13 cameras, as shown in FIG. 8. Alternately, the 49 cameras in FIG. 2 could be deployed in a much larger cross linear pattern of 25 cameras in each of the horizontal and vertical directions, with an increase in precision of a factor of roughly 2×2=4 (precision is roughly logarithmic in relation to the number of cameras in each direction).

Notwithstanding the advantages as described above concerning the cross arrangement of cameras, a camera arrangement including two linear camera arrays intersecting each other somewhere off the center of the two arrays may be employed in the system 1. For example, two linear camera arrays may intersect at the edge of each linear array, resulting in what could be called a corner-intersection.

The exemplary camera arrangements described above involve a plurality of cameras 50-1, . . . , 50-N as shown in FIG. 6, the system 1 may comprise only one camera for obtaining a 3D or 4D light field. For example, a single camera may be mounted on a precise stepper-motor and moved to viewpoints from which the camera is required to capture the scene. This configuration may be referred to as a gantry construction. A gantry construction may be inexpensive, and simple to calibrate since the images taken from the separate positions have identical camera parameters.

Further, in case of using a single camera, object(s) of the scene may be moved instead of moving the camera. For example, scene objects may be placed on a board and the board may be moved while the camera is at a fixed location. The fixed camera may capture images from viewpoints arranged in a grid, 1D array or 2D subarray (see e.g. FIGS. 2, 7 and 8) in relation to the scene, by moving the board on which the scene is constructed. Fixing the camera locations and moving the scene object(s) may also be carried out in cases arrangements of multiple cameras.

Moreover, it should be appreciated by those skilled in the art that the number of viewpoints (or cameras) arranged in one direction of the grid, 1D array or 2D subarray is not limited to the numbers shown in FIGS. 2, 7 and 8, where one direction of array includes seven viewpoints. The number of viewpoints in one direction may be any number which is larger than two.

### Functional Configurations

FIG. 9 shows an exemplary functional block diagram of the image processing apparatus 10 shown in FIG. 6. In FIG. 9, the image processing apparatus 10 includes an image receiving unit 100, an epipolar plane image (EPI) generation unit 102, an orientation determination unit 104, a model selection unit 106 and a 3D reconstruction unit 108.

The image receiving unit 100 is configured to receive captured images from one or more cameras. The image receiving unit 100 may pass the received images to the EPI generation unit 102.

The EPI generation unit 102 is configured to generate EPIs from captured images received at the image receiving unit 100. For example, the EPI generation unit 102 may generate a set of horizontal EPIs L_{y*, t*} and a set of vertical EPIs L_{x*, s*}, as explained above referring to FIGS. 3 and 4 as well as Equations (1) and (2). In one example, the EPI generation unit 102 may generate only horizontal EPIs or vertical EPIs.

The orientation determination unit 104 is configured to determine orientations of lines that appear in EPIs generated by the EPI generation unit 102. The determined orientations of lines may be used by the 3D reconstruction unit 108 for determining disparity values or depth values of pixels in an image to be reconstructed. The orientation determination unit 104 shown in FIG. 9 includes a single orientation model unit 1040 and a multiple orientation model unit 1042.

The single orientation model unit 1040 is configured to determine an orientation of a single line passing through any one of pixels in an EPI. As described above referring to FIG. 3 and Equations (2) and (3), the projection of point P on an EPI may be a straight line with a slope f/Z, where Z is the depth of P, i.e. the distance from P to the plane Π, and f is the focal length, i.e. the distance between the planes Π and Ω. The quantity f/Z is called the disparity of P. In particular, the explanation above means that if P is a point on an opaque Lambertian surface, then for all points on the epipolar plane image where the point P is visible, the light field L must have the same constant intensity. This is the reason why the single pattern of solid lines may be observed in the EPIs of a Lambertian scene (see e.g. FIGS. 4 and 5). The single orientation unit 1040 may assume that the captured scene includes Lambertian surfaces that may appear as a single line passing through a pixel in an EPI. Based on this assumption, the single orientation unit 1040 may determine a single orientation for any one of the pixels in an EPI, where the single orientation is an orientation of a single line passing through the pixel of interest.

However, as mentioned above, many natural scenes may include non-Lambertian surfaces, or so called non-cooperative surfaces. For instance, a scene may include a reflective and/or transparent surface. FIG. 10A shows an example of a captured image of a scene including a reflective surface. An EPI generated from images of a scene including a non-cooperative surface may comprise information from a plurality of signals. For example, when a scene includes a reflective surface, an EPI may include two signals, one from the reflective surface itself and the other from a reflection on the reflective surface. These two signals may appear as two lines passing through the same pixel in an EPI. FIG. 10B shows an example of an EPI generated using captured images of a scene with a reflective surface as shown in FIG. 10A. The EPI shown in FIG. 10B includes two lines passing through the same pixel.

Although the exemplary EPI shown in FIG. 10B (and in FIGS. 4 and 5) appear to include straight lines, it should be noted that lines passing through the same pixel in an EPI may also be curved. For example, a curved line may appear in an EPI when a captured scene includes a non-cooperative surface that is not planar but curved. The methods of the exemplary embodiments described herein may be applied regardless of whether the lines in an EPI are straight lines, curved lines or a mixture of both.

Referring again to FIG. 9, the multiple orientation model unit 1042 is configured to determine two or more orientations of lines passing through any one of the pixels in an EPI. The multiple orientation model unit 1042 may include a double orientation model unit that is configured to determine two orientations of (two) lines passing through the same pixel in an EPI. Alternatively or in addition, the multiple orientation model unit 1042 may include a triple orientation model unit that is configured to determine three orientations of (three) lines passing through the same pixel in an EPI. More generally, the multiple orientation model unit 1042 may include an N-orientation model unit (N=2, 3, 4, . . . ) that is configured to determine N orientations of (N) lines passing through the same pixel in an EPI. The multiple orientation model unit 1042 may include any one or any combination of N-orientation model units with different values of N.

Multiple orientation model unit 1042 may account for situations in which non-cooperative surfaces in a scene result in two or more lines passing through the same pixel in an EPI, as described above with reference to FIGS. 10A and 10B. Here, an idealized appearance model for the EPIs in the presence of a planar mirror that may be assumed by the double orientation model unit will be explained as an exemplary appearance model.

Referring to FIG. 11, let M⊂ [symbol] ³ be the surface of a planar mirror. Further, coordinates (y*, t*) are fixed and the corresponding EPI L_{y*, t*} is considered. The idea of the appearance model is to define the observed color for a ray at location (x, s) which intersects the mirror at mεM. A simplified assumption may be that the observed color is a linear combination of two contributions. The first is the base color c(m) of the mirror, which describes the appearance of the mirror without the presence of any reflection. The second is the color c(p) of the reflection, where p is the first scene point where the reflected ray intersects the scene geometry. Higher order reflections are not considered, and it is assumed that the surface at p is Lambertian. It is also assumed that the reflectivity α>0 is a constant independent of viewing direction and location. The EPI itself will then be a linear combination

L_{y*,t*}=L_{y*,t*}^{M}+αL_{y*,t*}V (4)

of a pattern L_{y*,t*}^{M} from the mirror surface itself as well as a pattern L_{y*,t*}^{V} from the virtual scene behind the mirror. For each point (x, s) in Equation (4), both constituent patterns have a dominant direction corresponding to the disparities of m and p. The double orientation model unit may extract these two dominant directions. The details on how to extract these two directions or orientations will be described later in connection with processing flows of the image processing apparatus 10.

In case a translucent surface is present, it should be appreciated by those skilled in the art that such a case may be explained as a special case of FIG. 11 and Equation (4), where a real object takes the place of the virtual one behind the mirror.

Referring again to FIG. 9, the model selection unit 106 is configured to select, according to a predetermined rule, the single orientation determined by the single orientation model unit 1040 or the two or more orientations determined by the multiple orientation model unit 1042 to be used for determining the disparity values or depth values by the 3D reconstruction unit 108. As described above, the single orientation model unit 1040 may assume a scene with Lambertian surfaces and the multiple orientation model unit 1042 may assume a scene with non-Lambertian, i.e. non-cooperative, surfaces. Accordingly, if a scene includes more Lambertian surfaces than non-Lambertian surfaces, using the results provided by the single orientation model unit 1040 may lead to more accurate determination of disparity values or depth values than using the results provided by the multiple orientation model unit 1042. On the other hand, if a scene includes more non-Lambertian surfaces than Lambertian surfaces, the use of the multiple orientation model unit 1042 may yield more accurate determination of disparity values or depth values than the use of the single orientation model unit 1040. As such, the predetermined rule on which the model selection unit 108 bases its selection may consider the reliability of the single orientation model unit 1040 and/or the reliability of the multiple orientation model unit 1042. Specific examples of the predetermined rule will be described later in connection with the exemplary process flow diagrams for the image processing apparatus 10.

The 3D reconstruction unit 108 is configured to determine disparity values or depth values for pixels in an image of the scene, i.e. an image to be reconstructed, based on the orientations determined by the orientation determination unit 104. In one example, the 3D reconstruction unit 108 may first refer to the model selection unit 106 concerning its selection of the single orientation model unit 1040 or the multiple orientation model unit 1042. Then the 3D reconstruction unit 108 may obtain orientations determined for pixels in EPIs from the single orientation model unit 1040 or the multiple orientation model unit 1042 depending on the selection made by the model selection unit 106. Since orientations of lines in EPIs may indicate disparity or depth information (see e.g., Equation (3)), the 3D reconstruction unit 108 may determine disparity values or depth values for pixels in an image to be reconstructed from the orientations determined for corresponding pixels in the EPIs.

### 3D Reconstruction Process

Exemplary processing performed by the image processing apparatus 10 will now be described, referring to FIGS. 12 to 14.

FIG. 12 shows a flow chart of an exemplary processing performed by the image processing apparatus 10. The exemplary processing shown in FIG. 12 may be started, for example, in response to a user input instructing the apparatus to start the processing.

In step S10, the image receiving unit 100 of the image processing apparatus 10 may receive captured images from one or more cameras connected to the image processing apparatus 10. In this example, the one or more cameras are arranged or controlled to move to predetermined locations for capturing images of a scene, appropriate for constructing a 4D light field. In other words, the captured images received in step S10 in this example include images captured at locations (s, t) as shown FIG. 3.

Next, in step S20, the EPI generation unit 102 generates horizontal EPIs and vertical EPIs using the captured images received in step S10. For example, the EPI generation unit 102 may generate a set of horizontal EPIs L_{y*, t*} by stacking pixel rows (x, y*) taken from the images captured at locations (s, t*) (see e.g. FIGS. 3 and 4; Equations (1) and (2)). Analogously, the EPI generation unit 102 may generate a set of vertical EPIs L_{x*, s*} by stacking pixel columns (x*, y) taken from the images captured at locations (s*, t). The EPI generation unit 102 may provide the horizontal EPIs and the vertical EPIs to the orientation determination unit 104.

The orientation determination unit 104 determines, in step S30, two or more orientations of lines passing through any one of the pixels in each of the vertical and the horizontal EPIs. In this example, the multiple orientation model unit 1042 of the orientation determination unit 104 performs the processing of step S30. The multiple orientation model unit 1042 may, for instance, perform an Eigensystem analysis of the N-th order structure tensor in order to determine N (=2, 3, 4, . . . ) orientations of lines passing through a pixel in an EPI. Here, as an example, detailed processing of step S30 in case of N=2 will be described below.

As described above with reference to FIG. 11 and Equation (4), the double orientation model unit configured to determine two orientations for a pixel in an EPI may assume that an EPI is a linear combination of a pattern from a reflecting or transparent surface itself and a pattern from a virtual scene or an object being present behind the reflecting or transparent surface.

In general, a region R⊂Ω of an image f:Ω→ [symbol] has an orientation vε [symbol] ² if and only if f(x)=f(x+αv) for all x, x+αvεR. The orientation v may be given by the Eigenvector corresponding to the smaller Eigenvalue of the structure tensor of f. A structure tensor of an image f may be represented by a 2×2 matrix that contains elements involving partial derivatives of the image f, as known in the field of image processing. However, this model of single orientation may fail if the image f is a superposition of two oriented images, f=f₁+f₂, where f₁ has an orientation u and f₂ has an orientation v. In this case, the two orientations u, v need to satisfy the conditions

u^{T}∇f₁=0 and v^{T}∇f₂=0 (5)

individually on the region R. It should be noted that the image f=f₁+f₂ has the same structure as the EPI as defined in Equation (4).

Analogous to the single orientation case, the two orientations in a region R may be found by performing an Eigensystem analysis of the second order structure tensor,

$$T = {\int }_{R} σ [ \begin{matrix}{f}_{xx}^{2} & {f}_{xx} {f}_{xy} & {f}_{xx} {f}_{yy} \\ {f}_{xx} {f}_{xy} & {f}_{xy}^{2} & {f}_{xy} {f}_{yy} \\ {f}_{xx} {f}_{yy} & {f}_{xy} {f}_{yy} & {f}_{yy}^{2}\end{matrix} ] d ( x , y ) , \qquad ( 6 )$$

where σ is a (usually Gaussian) weighting kernel on R, which essentially determines the size of the sampling window, and where fₓₓ, f_{xy} and f_{yy} represent second order derivatives of the image f. Since T is symmetric, Eigenvalues and Eigenvectors of the second order structure tensor T may be computed in a straight-forward manner known in linear algebra. Analogous to the Eigenvalue decomposition of the 2D structure tensor, i.e. the 2×2 matrix in the above-described single orientation case, the Eigenvector aε [symbol] ³ corresponding to the smallest Eigenvalue of T, the so called MOP vector (mixed orientation parameters vector), encodes the two orientations u and v. That is, the two orientations u and v may be obtained from Eigenvalues λ+, λ− of the following 2×2 matrix

$$[ \begin{matrix}{a}_{2} / {a}_{1} & - {a}_{3} / {a}_{1} \\ 1 & 0\end{matrix} ] . \qquad ( 7 )$$

The orientations are givens as u=[λ+1]^{T} and v=[λ−1]^{T}. When the above-described Eigensystem analysis is performed on an EPI L_{y*,t*}=L_{y*,t*}^{M}+αL_{y*,t*}^{V} as defined in Equation (4), assuming f=L_{y*,t*}, f₁=L_{y*,t*}^{M} and f₂=αL_{y*,t*}^{V}, the two disparity values corresponding to the two orientations of components L_{y*,t*}^{M} and αL_{y*,t*}^{V} are equal to the Eigenvalues λ+, λ− of the matrix as shown in Equation (7).

FIG. 13 shows an exemplary flow chart of the above-described processing of determining two orientations for a pixel in an EPI. The exemplary processing shown in FIG. 13 may be performed by the double orientation model unit comprised in the multiple orientation model unit 1042. FIG. 13 may be considered as showing one example of the detailed processing of step S30 in FIG. 12. The exemplary processing shown in FIG. 13 may start when step S30 of FIG. 12 is started.

At step S300 in FIG. 13, the horizontal and vertical EPIs generated in step S20 of FIG. 12 are smoothed using image smoothing technique known in the art. For example, smoothing by Gaussian filter may be performed on the EPIs at step S300.

Next in step S302, the double orientation model unit calculates first order derivatives, fₓ and f_{y}, for every pixel in each of the horizontal and vertical EPIs. Note that for horizontal EPIs, it is assumed that f=L_{y*,t*}=L_{y*,t*}^{M}+αL_{y*,t*}^{V} and for vertical EPIs, it is assumed that f=L_{x*,s*}=L_{x*,s*}^{M}+αL_{x*,s*}^{V}. The first order derivatives fₓ and f_{y} may be calculated, for example, by taking a difference between the value of a pixel of interest in the EPI and the value of a pixel next to the pixel of interest in the respective directions x and y.

Further in step S304, the double orientation model unit calculates second order derivatives, fₓₓ, f_{xy} and f_{yy}, for every pixel in each of the horizontal and vertical EPIs. The second order derivatives fₓₓ, f_{xy} and f_{yy} may be calculated, for example, by taking a difference between the value of the first order derivative of a pixel of interest in the EPI and the value of the first order derivative of a pixel next to the pixel of interest in the respective directions x and y.

Once the second order derivatives are calculated, the second order structure tensor T is formed in step S306, for every pixel in each of the horizontal and vertical EPIs. As can be seen from Equation (6), the second order structure tensor T may be formed with multiplications of all possible pairs of the second order derivatives ffₓₓ, f_{xy} and f_{yy}.

Next, in step S308, the double orientation model unit calculates Eigenvalues of every second order structure tensor T formed in step S306.

Then, in step S310, the double orientation model unit selects, for every second order structure tensor T, the smallest Eigenvalue among the three Eigenvalues calculated for the second order structure tensor T. The double orientation model unit then calculates an Eigenvector a for the selected Eigenvalue using, for instance, a standard method of calculation known in linear algebra. In other words, the double orientation model unit selects the Eigenvector a with the smallest Eigenvalue from the three Eigenvectors of the second order structure tensor T.

In step S312, the double orientation model unit forms, for every Eigenvector a selected in step S310, a 2×2 matrix A as shown in Equation (7), using the elements of the Eigenvector a.

In step S314, the double orientation model unit calculates Eigenvalues λ+, λ− of every matrix A formed in step S312.

Finally in step S316, two orientations u and v for every pixel in each of the horizontal and vertical EPIs are obtained as u=[λ+1]^{T}, v=[λ−1]^{T}, using the Eigenvalues λ+, λ− calculated for that pixel.

After step S316, the processing as shown in FIG. 13 ends. That is, the processing of step S30 shown in FIG. 12 ends. Accordingly, after the processing as shown in FIG. 13 ends, the image processing apparatus 10 may proceed to perform step S35 of FIG. 12.

Referring again to FIG. 12, in step S35, the single orientation model unit 1040 determines, for every pixel in each of the horizontal and vertical EPIs, an orientation of a single line passing through the pixel. The determination may be made, for example, by computing Eigenvectors of the structure tensor of each of the EPIs, as described above, referred to as the model of single orientation.

The orientation determination unit 104 may provide the orientations determined in steps S30 and S35 to the model selection unit 106 and the 3D reconstruction unit 108.

Next, in step S40, the 3D reconstruction unit 108 obtains disparity values or depth values of pixels in an image to be reconstructed using the orientations determined in steps S30 and S35. For example, in case double orientations have been determined in step S30 according to FIG. 13 and the 3D reconstruction unit 108 reconstructs an image from a particular viewpoint (s*, t*), the following values may be available for each pixel point (x, y) in the image to be reconstructed:
orientation u=[λ+1]^{T} for a pixel corresponding to (x, y) calculated from a horizontal EPI L_{y, t*} (determined in step S30);
orientation v=[λ−1]^{T} for a pixel corresponding to (x, y) calculated from a horizontal EPI L_{y, t*} (determined in step S30);
orientation u=[λ+_{1]T} for a pixel corresponding to (x, y) calculated from a vertical EPI L_{x, s*} (determined in step S30);
orientation v=[λ−1]^{T} for a pixel corresponding to (x, y) calculated from a vertical EPI L_{x, s*} (determined in step S30);
a single orientation for a pixel corresponding to (x, y) calculated from a horizontal EPI L_{y, t*} (determined in step S35); and
a single orientation for a pixel corresponding to (x, y) calculated from a vertical EPI L_{x, s*} (determined in step S35).

A slope represented by each of the orientations (vectors) listed above may be considered an estimated value of disparity, i.e. focal length f/depth Z (see e.g. Equation (3) above), of a scene point appearing on the pixel point (x, y) in the image to be reconstructed. Accordingly, the 3D reconstruction unit 108 may determine, from the orientations above, estimated disparity values or depth values for every pixel point (x, y) in the image to be reconstructed.

The closer depth estimate in the double orientation model will always correspond to the primary surface, i.e. a non-cooperative surface itself, regardless of whether it is a reflective or translucent surface.

As a consequence of the processing of steps S10 to S40, more than one disparity value or depth value may be determined for a pixel point (x, y) in the image to be reconstructed. For instance, in the most recent example above, six disparity values corresponding to the six available orientations listed above may be determined for one pixel point (x, y).

Thus, in step S50, the 3D reconstruction unit 108 creates a disparity map or a depth map which contains one disparity or depth value for one pixel point. In one example, the 3D reconstruction unit 108 may create a disparity/depth map corresponding to each of the multiple orientations determined in step S30. Accordingly, in the case of double orientation, two disparity/depth maps, each of which corresponding to the two determined orientations, may be created. In this case, one of the two disparity/depth maps with closer depth estimations may represent a front layer including reconstructed 3D information of non-cooperative surfaces in the scene. Further, the other one of the two disparity/depth maps with farther depth estimations may represent a back layer including reconstructed 3D information of (virtual) objects behind the non-cooperative surfaces. Two depth/disparity estimates corresponding to the two orientations may be used for determining the disparity/depth value to be included for a pixel point in the disparity/depth maps of the respective layers. Nevertheless, for pixel points representing Lambertian surfaces in the scene, disparity/depth estimates from the single orientation model may provide more accurate disparity/depth values.

Thus, in step S50, the 3D reconstruction unit 108 may instruct the model selection unit 106 to select disparity or depth values obtained from a particular model, i.e. a single orientation model or a multiple orientation model, for use in determining the depth/disparity value for a pixel point in a disparity/depth map. The selection unit 106 performs such a selection according to a predetermined rule. Based on the selection made by the model selection unit 106, the 3D reconstruction unit 108 may merge the disparity or depth values of the selected model, obtained from vertical and horizontal EPIs, into one disparity or depth value for the pixel point.

FIG. 14 shows an example of detailed processing performed in step S50 of FIG. 12. The processing shown in FIG. 14 may start when the processing of step S50 of FIG. 12 has been started.

In step S500, the model selection unit 106 compares disparity/depth values obtained from a horizontal EPI and a vertical EPI for a pixel point (x, y) in an image to be reconstructed. In one example, the model selection unit 106 may perform this comparison concerning the multiple orientation model. In this example, the model selection unit 106 may calculate, for each one of the determined multiple orientations, a difference between an estimated disparity/depth value obtained from a horizontal EPI and an estimated disparity/depth value obtained from a vertical EPI.

In the case of a double orientation model, the model selection unit 106 may calculate:
a difference between a disparity/depth value obtained from orientation u of a horizontal EPI and a disparity/depth value obtained from orientation u of a vertical EPI; and
a difference between a disparity/depth value obtained from orientation v of a horizontal EPI and a disparity/depth value obtained from orientation v of a vertical EPI.

If the calculated difference is less than or equal to a predetermined threshold 8 for all orientations of the multiple orientations (YES at step S502), the processing proceeds to step S504 where the disparity/depth values of the multiple orientations will be used for creating the disparity/depth map. If not (NO at step S502), the processing proceeds to step S506 where the disparity/depth values of the single orientation will be used for creating a disparity/depth map.

For example, in the case of the double orientation model, if the above-defined difference concerning orientation u and the above-defined difference concerning orientation v are both less than or equal to the predetermined threshold 8, the processing proceeds from step S502 to step S504. Otherwise, the processing proceeds from step S502 to step S506.

The condition for the determination in step S502 may be considered as one example of a predetermined rule for the model selection unit 106 to select the single orientation model or the multiple orientation model. When the condition of step S502 as described above is met, it may be assumed that the multiple orientation model may provide more accurate estimations of disparity/depth values. On the other hand, when the condition of step S502 as described above is not met, it may be assumed that the single orientation model may provide more accurate estimations of disparity/depth values.

In step S504, the 3D reconstruction unit 108 determines, using the disparity values obtained from the multiple orientation model, a disparity/depth value for the pixel point (x, y) at issue to be included in disparity/depth maps corresponding to the multiple orientations. In the exemplary case of the double orientation model, the 3D reconstruction unit 108 may create a disparity/depth map corresponding to each of the orientations u and v. As described above in this case, for each of the orientations u and v, two estimated disparity/depth values are available for the pixel point (x, y) obtained from the horizontal and vertical EPIs. The 3D reconstruction unit 108 may determine a single disparity/depth value using the two estimated values.

For example, the 3D reconstruction unit 108 may perform statistical operations on the two estimated values. An exemplary statistical operation is to take a mean value of the disparity/depth values obtained from the horizontal and vertical EPIs.

Alternatively, the 3D reconstruction unit 108 may simply select, according to predetermined criteria, one of the two estimated values as the disparity/depth value for the pixel point. An example of the criteria for the selection may be to evaluate the quality or reliability for the two estimated values and to select the value with the higher quality or reliability. The quality or reliability may be evaluated, for instance, by taking differences between the Eigenvalues of the second order structure tensor based on which the estimated disparity/depth value has been calculated. For example, let μ1, μ2 and μ3 be the three Eigenvalues of the second order structure tensor T in ascending order. The quality or reliability may be assumed to be higher if both of the differences, μ2−μ1 and μ3−μ1 are greater than the difference μ3−μ2.

After step S504, the processing proceeds to step S508.

In step S506, the 3D reconstruction unit 108 determines, using the disparity values obtained from the single orientation model, a disparity/depth value for the pixel point (x, y) at issue to be included in disparity/depth maps corresponding to the multiple orientations. Here, as described above, two estimated disparity/depth values are available for the pixel point obtained from horizontal and vertical EPIs in the single orientation determination step S35.

Similarly to step S504, the 3D reconstruction unit 108 may determine a single disparity/depth value from the two estimated values, in a manner similar to that described concerning step S504.

After step S506, the processing proceeds to step S508.

In step S508, a determination is made as to whether all pixel points in the image to be reconstructed have been processed. If YES, the processing shown in FIG. 14 ends. If NO, the processing returns to step S500.

When the exemplary processing shown in FIG. 14 ends, disparity/depth maps corresponding to the multiple orientations have been generated. Every pixel point (x, y) in these maps includes a disparity/depth value determined using either the single orientation model or the double orientation model. Then the processing of step S50 shown in FIG. 12 ends and all the processing steps shown in FIG. 12 ends.

From the disparity/depth values in the disparity/depth maps generated as a result of the processing described above with reference to FIGS. 12 to 14, metric depth values may be calculated using a conventional method known to those skilled in the art. The conventional method may involve calibration of the camera(s) used for capturing the images of the scene. An exemplary calibration process may include capturing a known pattern, e.g. a checkerboard pattern, from different locations with the camera(s) and obtaining calibration factors to convert the disparity/depth values calculated by the methods of the exemplary embodiments described above into metric depth values.

### Variations

It should be appreciated by those skilled in the art that the embodiments and their variations as described above with reference to FIGS. 1 to 14 are merely exemplary and other embodiments and variations may exist.

For instance, in one exemplary embodiment, the orientation determination unit 104 of the image processing apparatus 10 may include only the multiple orientation model unit 1042 and not the single orientation model unit 1040. In this exemplary embodiment, the model selection unit 106 is not necessary. In this exemplary embodiment, the 3D reconstruction unit 108 may create disparity/depth maps corresponding to the multiple orientations determined by the multiple orientation model unit 1042 using disparities/depths obtained for each of the multiple orientations, in a manner similar to the above-described processing step S504 of FIG. 14.

Further, in the embodiments and variations as described above, an image to be reconstructed has the same resolution as the captured images, as every pixel point (x, y) corresponding to every pixel (x, y) in a captured image is processed. However, in an exemplary variation of embodiments as described above, an image to be reconstructed may comprise a higher or lower number of pixels in comparison to the captured images. When reconstructing an image having a higher number of pixels, for example, an interpolation may be made for a pixel point that does not have an exact corresponding pixel in the EPIs, using disparity/depth values estimated for neighboring pixels. When reconstructing an image with a lower number of pixels, for example, the disparity/depth value for a pixel point may be determined as a value representing disparity/depth values estimated for a plurality of neighboring pixels (e.g. a mean value).

Further, in the embodiments and variations as described above, estimated disparity/depth values for every pixel in each of all vertical and horizontal EPIs are determined using the single orientation model and the multiple orientation model. However, in an exemplary variation, only some of the pixels in some of the vertical and horizontal EPIs may be processed if, for example, the estimations from other pixels are not needed for desired reconstruction. For instance, when it is known that certain pixels always belong to an area of no interest, e.g. the scene background, processing of those pixels may be skipped.

Moreover, in one exemplary embodiment, only vertical EPIs or horizontal EPIs may be generated, instead of generating both vertical and horizontal EPIs. In this embodiment, no processing for merging two disparity/depth values from horizontal and vertical EPIs is required. One disparity/depth estimate for each orientation determined for a pixel in an EPI (either horizontal or vertical) may be available for creating disparity/depth maps.

Further, the embodiments and their variations are described above in relation to an exemplary case of using the double orientation model, i.e. determining two orientations for a pixel in an EPI. In the embodiments and their variations, a triple or higher orientation model may also be applied. For example, in case of the triple orientation model, three orientations passing through a pixel in an EPI may be determined and three disparity/depth maps respectively corresponding to the three orientations may be created. It may be assumed that such three orientations correspond to: a pattern representing a transparent surface in the scene; a pattern representing a reflection on the surface; and a pattern representing an object behind the transparent surface. For determining three orientations, processing analogous to that shown in FIG. 13 may be employed. For example, a third order structure tensor may be formed using third order derivatives of an EPI, an Eigenvector of the third order structure tensor with the smallest Eigenvalue may be selected and further Eigenvalue calculation may be made on a matrix formed with the selected Eigenvector.

### Experimental Results

FIGS. 15, 16 and 17 show examples of experimental results of 3D reconstruction. FIG. 15(a), FIG. 16(a) and FIG. 17(a) show images captured for forming a 4D light field from a center of the arranged viewpoints. FIG. 15(b) shows a resulting image of 3D reconstruction by a multi-view stereo method. FIG. 16(b) and FIG. 17(b) show resulting images of 3D reconstruction using disparity/depth values obtained by a method according to the single orientation model as described above. FIGS. 15(c), (d); FIGS. 16(c), (d); and FIGS. 17(c), (d) show resulting images of 3D reconstruction using disparity/depth values obtained by a method according to the double orientation model as described above. The captured scenes of FIGS. 15 and 16 include reflective surfaces and the captured scene of FIG. 17 include a semi-transparent surface. It can be seen from FIGS. 15 to 17 that the double orientation model may separate non-cooperative surfaces and the (virtual) objects behind the non-cooperative surfaces more accurately than a multi-view stereo method and a method according to the single orientation model.

1. An image processing apparatus for 3D reconstruction comprising:
an epipolar plane image generation unit configured to generate a first set of epipolar plane images from a first set of images of a scene, the first set of images being captured from a plurality of locations;
an orientation determination unit configured to determine, for pixels in the first set of epipolar plane images, two or more orientations of lines passing through any one of the pixels; and
a 3D reconstruction unit configured to determine disparity values or depth values for pixels in an image of the scene based on the orientations determined by the orientation determination unit.

2. The image processing apparatus according to claim 1,
wherein the orientation determination unit comprises a double orientation model unit that is configured to determine two orientations of lines passing through any one of the pixels;
wherein one of the two orientations corresponds to a pattern representing a surface in the scene; and
wherein the other one of the two orientations corresponds to a pattern representing a reflection on the surface or a pattern representing an object behind the surface that is transparent.

3. The image processing apparatus according to claim 1,
wherein the orientation determination unit comprises a triple orientation model unit that is configured to determine three orientations of lines passing through any one of the pixels, the three orientations respectively corresponding to three patterns of the following patterns:
a pattern representing a transparent surface in the scene;
a pattern representing a reflection on a transparent surface in the scene;
a pattern representing an object behind a transparent surface in the scene;
a pattern representing a reflection on a surface of an object behind a transparent surface in the scene;
a pattern representing a transparent surface in the scene behind another transparent surface in the scene; and
a pattern representing an object behind two transparent surfaces in the scene.

4. The image processing apparatus according to claim 1, wherein the determination of the two or more orientations includes an Eigensystem analysis of a second or higher order structure tensor on the epipolar plane image.

5. The image processing apparatus according to claim 1,
wherein the epipolar plane image generation unit is further configured to generate a second set of epipolar plane images from a second set of images of the scene, the second set of images being captured from a plurality of locations that are arranged in a direction different from a direction of arrangement for the plurality of locations from which the first set of images are captured; and
wherein the orientation determination unit is further configured to determine, for pixels in the second set of epipolar plane images, two or more orientations of lines passing through any one of the pixels.

6. The image processing apparatus according to claim 5,
wherein the orientation determination unit further comprises a single orientation model unit that is configured to determine, for pixels in the first set of epipolar plane images and for pixels in the second set of epipolar plane images, a single orientation of a line passing through any one of the pixels; and
wherein the image processing apparatus further comprises:
a selection unit that is configured to select, according to a predetermined rule, the single orientation or the two or more orientations to be used by the 3D reconstruction unit for determining the disparity values or depth values.

7. The image processing apparatus according to claim 6, wherein the predetermined rule is defined to select:
the single orientation when the two or more orientations determined for corresponding pixels in the first set and the second set of epipolar plane images represent disparity or depth values with an error greater than a predetermined threshold; and
the two or more orientations when the two or more orientations determined for corresponding pixels in the first set and the second set of epipolar plane images represent disparity or depth values with an error less than or equal to the predetermined threshold.

8. The image processing apparatus according to claim 5, wherein the 3D reconstruction unit is configured to determine the disparity values or the depth values for pixels in the image of the scene by performing statistical operations on the two or more orientations determined for corresponding pixels in epipolar plane images in the first set and the second set of epipolar plane images.

9. The image processing apparatus according to claim 5, wherein, for determining the disparity values or the depth values for pixels in the image of the scene, the 3D reconstruction unit is further configured to select, according to predetermined criteria, whether to use:
the two or more orientations determined from the first set of epipolar plane images; or
the two or more orientations determined from the second set of epipolar plane images.

10. A system for 3D reconstruction comprising:
an epipolar plane image generation unit configured to generate a first set of epipolar plane images from a first set of images of a scene, the first set of images being captured from a plurality of locations;
an orientation determination unit configured to determine, for pixels in the first set of epipolar plane images, two or more orientations of lines passing through any one of the pixels;
a 3D reconstruction unit configured to determine disparity values or depth values for pixels in an image of the scene based on the orientations determined by the orientation determination unit; and
a plurality of imaging devices that are located at the plurality of locations and that are configured to capture images of the scene.

11. The system according to claim 10,
wherein the plurality of imaging devices are arranged in two or more linear arrays intersecting with each other;
wherein the epipolar plane image generation unit is further configured to generate a second set of epipolar plane images from a second set of images of the scene, the second set of images being captured from a plurality of locations that are arranged in a direction different from a direction of arrangement for the plurality of locations from which the first set of images are captured; and
wherein the orientation determination unit is further configured to determine, for pixels in the second set of epipolar plane images, two or more orientations of lines passing through any one of the pixels.

12. A system for 3D reconstruction comprising:
an epipolar plane image generation unit configured to generate a first set of epipolar plane images from a first set of images of a scene, the first set of images being captured from a plurality of locations;
an orientation determination unit configured to determine, for pixels in the first set of epipolar plane images, two or more orientations of lines passing through any one of the pixels;
a 3D reconstruction unit configured to determine disparity values or depth values for pixels in an image of the scene based on the orientations determined by the orientation determination unit; and
at least one imaging device that is configured to capture images of the scene from the plurality of locations.

13. An image processing method for 3D reconstruction comprising:
generating a first set of epipolar plane images from a first set of images of a scene, the first set of images being captured from a plurality of locations;
determining, for pixels in the first set of epipolar plane images, two or more orientations of lines passing through any one of the pixels; and
determining disparity values or depth values for pixels in an image of the scene based on the determined orientations.

14. The method according to claim 13,
wherein the determination of the two or more orientations includes determining two orientations of lines passing through any one of the pixels;
wherein one of the two orientations corresponds to a pattern representing a surface in the scene; and
wherein the other one of the two orientations corresponds to a pattern representing a reflection on the surface or a pattern representing an object behind the surface that is transparent.

15. The method according to claim 13,
wherein the determination of the two or more orientations includes determining three orientations of lines passing through any one of the pixels, the three orientations respectively corresponding to:
a pattern representing a transparent surface in the scene;
a pattern representing a reflection on the transparent surface; and
a pattern representing an object behind the transparent surface.

16. The method according to claim 13, wherein the determination of the two or more orientations includes an Eigensystem analysis of a second or higher order structure tensor on the epipolar plane image.

17. The method according to claim 13, further comprising:
generating a second set of epipolar plane images from a second set of images of the scene, the second set of images being captured from a plurality of locations that are arranged in a direction different from a direction of arrangement for the plurality of locations from which the first set of images are captured; and
determining, for pixels in the second set of epipolar plane images, two or more orientations of lines passing through any one of the pixels.

18. The method according to claim 17, further comprising:
determining, for pixels in the first set of epipolar plane images and for pixels in the second set of epipolar plane images, a single orientation of a line passing through any one of the pixels; and
selecting, according to a predetermined rule, the single orientation or the two or more orientations to be used by the 3D reconstruction unit for determining the disparity values or depth values.

19. A non-transitory computer program product comprising computer-readable instructions that, when loaded and run on a computer having a processor and a memory, cause the computer to perform a method comprising:
generating a first set of epipolar plane images from a first set of images of a scene, the first set of images being captured from a plurality of locations;
determining, for pixels in the first set of epipolar plane images, two or more orientations of lines passing through any one of the pixels; and
determining disparity values or depth values for pixels in an image of the scene based on the determined orientations.

20. The non-transitory computer program product of claim 19,
wherein the determination of the two or more orientations includes determining two orientations of lines passing through any one of the pixels;
wherein one of the two orientations corresponds to a pattern representing a surface in the scene; and
wherein the other one of the two orientations corresponds to a pattern representing a reflection on the surface or a pattern representing an object behind the surface that is transparent.
